(19) United States
(12) Patent Application Publication
(10) Pub. No.: US 2013/0205213 A1
(43) Pub. Date: Aug. 8, 2013

(54) CAPTION-BASED NAVIGATION FOR A VIDEO PLAYER

(71) Applicant: edX Inc., Cambridge, MA (US)

(72) Inventor: Piotr F. Mitros, Cambridge, MA (US)

(73) Assignee: edX Inc., Cambridge, MA (US)

(21) Appl. No.: 13/760,707

(22) Filed: Feb. 6, 2013

Related U.S. Application Data
(60) Provisional application No. 61/595,383, filed on Feb. 6, 2012.
(60) Provisional application No. 61/714,331, filed on Oct. 16, 2012.

(51) Int. Cl. G06F 3/048

(52) U.S. Cl. CPC G06F 3/048
USPC 715/719

(57) ABSTRACT

A video player has scrolling text acting as a navigational aid for the video. The video player consists of a video, together with captions for an extended amount of time around the current point in the video.

### CROSS-REFERENCE TO RELATED APPLICATIONS

This application claims the benefit of U.S. Provisional Application No. 61/595,383, titled “Caption-Based Navigation for a Video Player,” filed Feb. 6, 2012. This application also claims the benefit of U.S. Provisional Application No. 61/714,331, titled “Educational Interface Navigation,” filed on Oct. 16, 2012. The contents of these applications are incorporated herein by reference.

This application is also related to copending U.S. application Ser. No. ______, titled “Online Distributed Interaction,” filed on Feb. 6, 2013, which claims the benefit of U.S. Provisional Application No. 61/595,307, filed on Feb. 6, 2012. The contents of these applications are incorporated herein by reference.

### BACKGROUND

This invention relates to caption-based navigation.

In online environments, for example, online education and learning, content is made available to users using a browser over the internet. In environments such as this it is useful to provide a way for the user to navigate through content to find particular sections of interest. One way to do so is with a time axis scrollbar associated with a video display. However, such a scrollbar can be inefficient in that the user cannot position the content at specific text.

### SUMMARY

In one aspect, a video player has scrolling text acting as a navigational aid for the video. The video player consists of a video, together with captions for an extended amount of time around the current point in the video.

In some examples, the scrolling text consists of text transcription of audio content being presented with video (e.g., live video such as a lecture, “blackboard” animation, etc.). In other applications, scrolling text corresponding to associated text material, such a content-aligned discussions (e.g., questions/answer chat environments) can be used to position the text.

In some examples, such content-aligned text scrolls in synchrony with the audio-video (or video only) content being presented. In some examples, video and/or animation, audio, and content-aligned text are all presented in synchrony. In some such examples, the user can control a location and/or rate of presentation of one of the modes (video, text, audio) and cause synchronized presentation in the other modes. For example, selecting text can control the location of the presentation of a blackboard animation, and controlling a selection of a blackboard location (e.g., with a slider, with selection of thumbnails, etc.) can control the location of the presentation of the scrolling text transcript.

In addition to positioning the content by selecting a location in content-aligned text, the user can also cause playback of the range of content by selecting a range of content-aligned text.

In some examples, the content-aligned text and the video are both linear (e.g., have a single axis, such as time). In other examples, the content is structured (e.g., tree structured, with optional sections, etc.) and the content-aligned text has similar structure.

In some examples, the presentation of the video effectively serves as an animated figure or drawing that accompanies a text. For example, an online or electronic textbook or lecture may be presented in an interface (e.g., in an online interface, or on a downloaded “e-book”) in which a text (linear or structured text) is presented in one portion (e.g., bottom or left pane) of an interface and an animated figure or video is presented in another section (e.g., top or right pane) of the interface. The two sections are synchronized in presentation to the user.

Other features and advantages of the invention are apparent from the following description, and from the claims.

### DESCRIPTION OF DRAWINGS

FIG. 1 is a schematic view of a user interface screen.

FIG. 2 is an example of an interface screen.

### DESCRIPTION

An online education system provides access to students to educational material through an interactive computer implemented graphical interface. The educational material is arranged into courses, much as material is arranged into courses in a traditional university setting. The material for a course may be intended for presentation over an extended time period (e.g., over a three-month semester). A number of different organizations of the material are presented to the student to allow them to navigate to different parts of material for a course, and between different courses. It should be understood that the presentation of educational material for a college course is only an illustrative example, and the approaches described herein are applicable to a much wider range of educational and training systems and to a variety of users (i.e., not necessarily students).

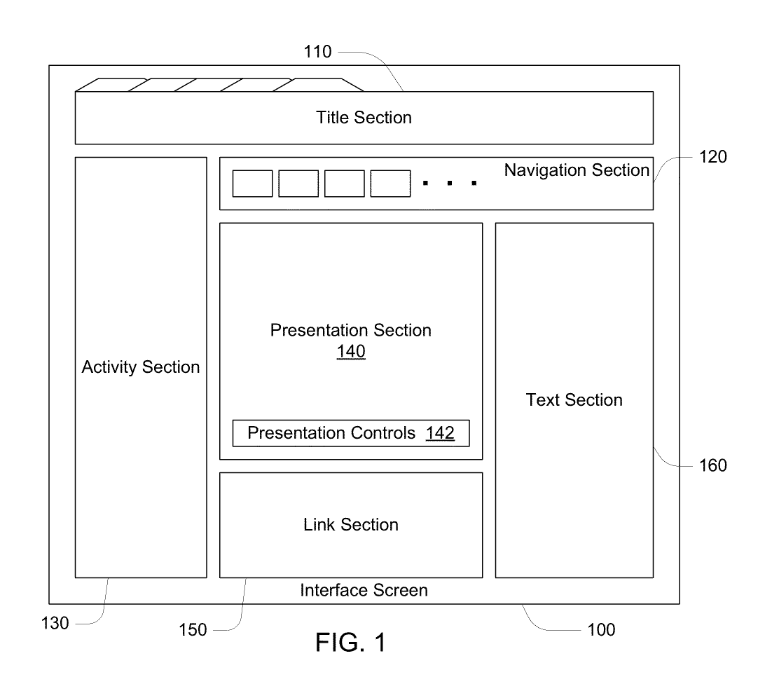

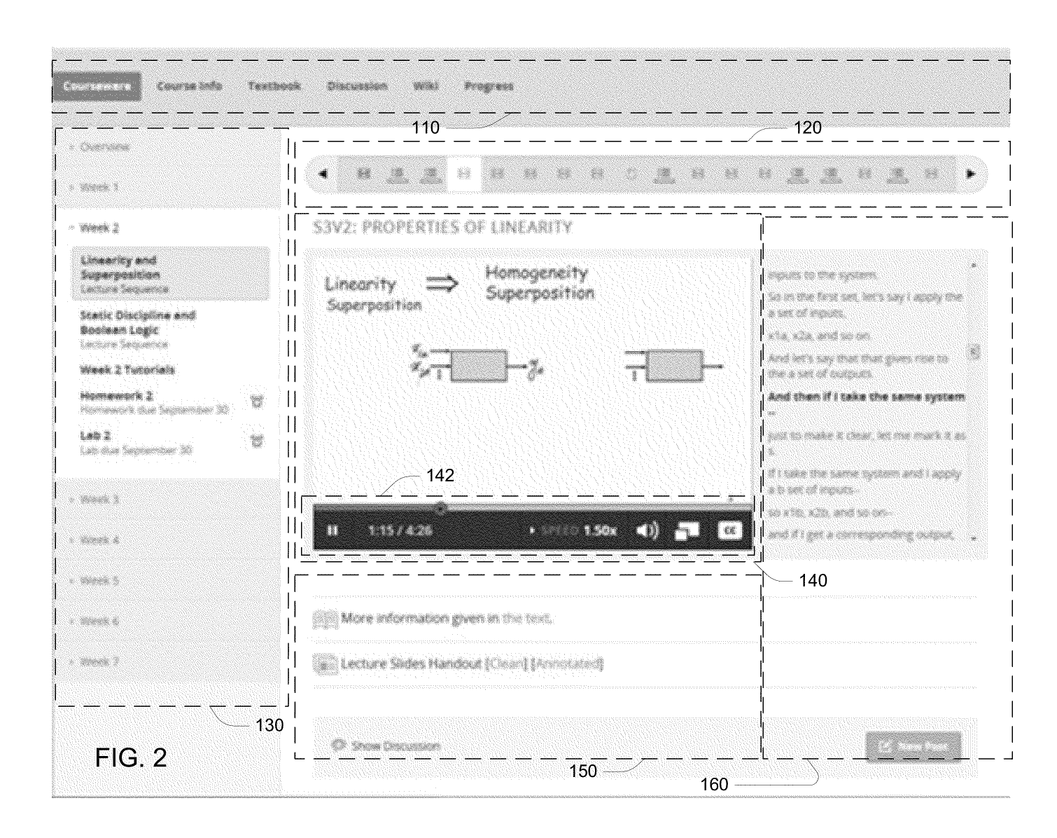

Referring to FIG. 1, a representative screen 100 of a user interface includes a number of sections. An example of a screen of a specific embodiment of the system is shown in FIG. 2. A title section 110 shows an identification of the course being presented through the interface, optionally with navigation controls (e.g., tabs, search boxes etc.) for changing the course being presented, for example, when a student is concurrently registered in multiple courses. An activity section 130 provides a “table of contents” view of the material, for example, using a list of parts (e.g., lessons), possibly arranged in hierarchical manner with parts grouped within chapters or other divisions. This activity axis can be viewed as one type of progress axis. This section provides the student with control to jump to selected parts of the material for a course. A presentation section 140, shown in this example in a central portion of the screen, is used to present the actual content, for example, in the form of recorded video or animation (e.g., video of a lecturer, animation of a “blackboard”, etc.). A presentation control section 142 provides controls for the presentation, for instance, conventional pause, fast forward, next scene, controls as are conventional for video playback.

An optional discussion section or a link to a text section 160 of the screen 100 provides a transcript or captioning corresponding to the material in the presentation section 140, and in some embodiments, is used by the student to enter comments, questions, or other text input, and to view such inputs from other students or an instructor. One embodiment of such a discussion section is described in copending U.S. application Ser. No. ______, titled “Online Distributed Interaction,” filed on Feb. 6, 2013. A link section 150 provides links that the user can use to access supporting material for the course.

The tabs in the title section 110 as shown at to top of the screen 100 of FIG. 1 may include a tab for the global discussion forum. Other tabs may include among other features, a textbook, a grades section where the student can see their current progress and grade, a wiki for collaboration, a course information section where announcements and handouts are posted.

Each of the elements on the screen 100 can optionally be configured to be shrunk to a link or an icon to allow, for example, for more space for the other elements on the screen. Clicking on the icon, will expand the shrunk element.

In an exemplary embodiment, as the user is watching a video (e.g., educational content presented in an on-line course management system) the text in the text section 160 scrolls vertically in synchronization with the material being shown in the presentation section 140. In the case of a transcription of the presentation, the scrolling of the transcription is synchronized with the presentation such that the part of the presentation being shown matches the part of the transcription that is shown.

In this example, if the user missed some part of the presentation, they can select a location of the content of in the text section 160 reposition the presentation. For example, if the user reads ahead and knows the material that is coming up, they can click on the later transcription to move forward.

In some embodiments, the primary mode of viewing the presentation is by reading captions in the text section 160 rather than listening to the audio portion of the presentation (e.g., the audio of the lecturer speaking) In such an example, the view in the presentation section 140 tracks where the user is reading (for example based on how far the user has scrolled the section, or potentially using other methods (e.g., eye tracking) to more accurately determine where the user is reading.

In this example, the user can control a speed of presentation (e.g., with a speed control on the interface), which controls the speed at which the content is shown in the presentation section, and the speed at which the text in the text section 160 scrolls. In some cases, the audio (e.g., speech) for the presentation section can be accelerated (e.g., with pitch correction), but in other cases, the speedup can exceed the rate at which the audio of the presentation can be presented or at which the user could understand what is being said.

In some examples, user can select portions of the presentation by selecting parts of the text in the text section. For example, with the presentation paused, the user may select a past section of text in the text section, and a corresponding part of the presentation is shown or highlighted in the presentation section. As an example, if the presentation section includes a sequential writing on a board, selecting a past portion of the text in the text section may highlight the writing that was contemporaneous with the text. The highlighting may be accomplished by fading the non-selected portions of the presentation, or by brightening the selected portion, or other highlighting techniques.

Similarly, there are situations in which the user can select parts of the presentation section and have corresponding parts of the text section highlighted. As one example, when using the fast forward and rewind controls of the presentation section, the text section stays synchronized. As another example, when the user selects a part of the presentation image (e.g., by selecting a rectangle within the presentation area) the text that corresponds to the presentation within that area is highlighted.

In the examples, selecting text or presentation material can also be accomplished by simply hovering over the content, with the corresponding presentation and text parts being highlighted.

The approaches described above can be implemented in software, which includes instructions stored on a tangible medium (e.g., computer disk) for causing a processor to perform the functions described above. In some examples, the processor is hosted at a client computer that a user uses to view the content. In some examples, the processor is hosted at a server, which communicates with a client computer over a data network (e.g., the public Internet).

It is to be understood that the foregoing description is intended to illustrate and not to limit the scope of the invention, which is defined by the scope of the appended claims. Other embodiments are within the scope of the following claims.

What is claimed is:

1. A method for presentation of graphical content in conjunction with content-aligned text comprising:
determining a location in the content-aligned text according to an interaction with a user to whom the video content is being presented; and
presenting the graphical content at a location corresponding to the determined location in the content-aligned text.

2. The method of claim 1 wherein the graphical content comprises video content.

3. The method of claim 2 wherein the content aligned text comprises a transcription of audio corresponding to the video content.

4. The method of claim 2 wherein the content aligned text comprises captioning corresponding to the video content.

5. The method of claim 2 wherein the content aligned text comprises discussion text corresponding to the video content.

6. The method of claim 1 wherein presenting the video content the location comprises seeking the location in the video content and presenting the video content from that location.

7. The method of claim 1 wherein presenting the video content comprises adjusting a rate of presentation of the video content to match a rate of presentation of the content-aligned text.

8. The method of claim 1 wherein determining a location in the content-aligned text comprises determining a region of the text.

9. The method of claim 8 wherein presenting the graphical content at a location corresponding to the determined location in the content-aligned text comprises highlighting a portion of the graphical content.

10. The method of claim 1 further comprising
determining a location in the graphical content according to an interaction with a user to whom the video content is being presented; and
indicating a location in the content-aligned text corresponding to the determined location in the graphical content.

11. The method of claim 1 wherein the graphical content comprises educational material.

12. The method of claim 10 wherein the educational material comprises a lecture presentation.

13. Software tangibly stored on a machine-readable medium comprising instructions for causing a processor to:
determine a location in the content-aligned text according to an interaction with a user to whom the video content is being presented; and
present the graphical content at a location corresponding to the determined location in the content-aligned text.
